(19) United States
(12) Patent Application Publication
(10) Pub. No.: US 2017/0297283 A1
(43) Pub. Date: Oct. 19, 2017

(54) METHODS AND SYSTEMS FOR MOLD RELEASES

(71) Applicant: e-Vision Smart Optics, Inc., Sarasota, FL (US)

(72) Inventor: Anthony VAN HEUGTEN, Sarasota, FL (US)

(21) Appl. No.: 15/637,607

(22) Filed: Jun. 29, 2017

Related U.S. Application Data
(63) Continuation of application No. PCT/US2016/012121, filed on Jan. 5, 2016.
(60) Provisional application No. 62/099,716, filed on Jan. 5, 2015.

(51) Int. Cl. B29D 11/00; B29C 45/14; B29C 39/10; B29C 35/08; B29C 33/00; B29L 11/00

(52) U.S. Cl. CPC B29D 11/00211; B29C 39/10; B29D 11/00269; B29C 35/0888; B29C 45/14; B29L 2011/00; B29C 2033/0005

(57) ABSTRACT

Molding optical components with fine (e.g., micron-scale) features from optical adhesive or polymer can be difficult because the optical components often stick to the mold. If the component sticks to the mold, then either the component or the mold may be damaged or destroyed as the component is removed from the mold. This damage can be reduced or avoided altogether by illuminating the interface between the component and the mold with ultraviolet (UV) light before releasing the component from the mold. The UV light reduces the adhesive forces that cause the component and the mold to stick together, making it easier to remove the component from mold without damaging either the mold or the component.

### CROSS-REFERENCE TO RELATED APPLICATIONS

The present application is a bypass continuation of International Application No. PCT/US2016/012121, which was filed on Jan. 5, 2016, and which in turn claims the priority benefit, under 35 U.S.C. §119(e), of U.S. Application No. 62/099,716, entitled “Methods and Systems for Mold Releases”, which was filed on Jan. 5, 2015. Each of these applications is incorporated herein by reference in its entirety.

### BACKGROUND

Molding of shapes into materials is known by those skilled in the art in numerous forms. For example, there is injection molding, cast molding, and compression molding. The parts being molded are typically plastic, but many other materials such as glass and metal can be molded as well.

The basic process entails creating a mold with the shape in a negative form of the shape that is ultimately desired to be molded, bringing the mold into full contact with the material to be molded while the material to be molded is in a liquid or gel form that will allow deformation, causing the material to be molded to conform to the shape of the mold, causing or allowing the material that is to be molded to harden, then separating the mold from the part that has been molded.

In most instances the material to be molded does not adhere strongly to the mold surface and can be separated easily. For example, a steel mold filled with heated liquid Teflon, will separate with little or no adhesion after the Teflon has cooled and hardened.

### SUMMARY

In some cases, it may be desirable to mold a highly adhesive material, making it difficult or impossible to release the material from the mold without damaging the molded shape. For example, in an optical Fresnel lens, very fine structures are molded. The structures may have heights of only a few microns and a surface finish roughness of only tens of Angstroms. The structures are often not only very fine, but very fragile. In one exemplary manufacturing process, it is desirable to mold the Fresnel structures onto the surface of a substrate rather than mold the substrate and the Fresnel structures simultaneously in one step. Also, it can be desirable to mold the Fresnel structures from a highly adhesive material so that the material adheres strongly to the substrate. In such a situation of using a highly adhesive molding material, the material may adhere strongly to the substrate, which is wanted, and also adhere strongly to the mold, which is unwanted. In this condition, the molded material often cannot be separated from the mold without damage to the mold, the molded part, or both.

Examples of the present technology include processes that allow high adhesion materials to be molded, and then released from the mold without damage. One example includes a method of forming a molded component using a transparent mold and a molding material that at least partially absorbs ultraviolet light. The molding material is disposed in the mold and hardened in the mold so as to form the molded component, e.g., via irradiation or thermal curing. At least a portion of an interface between a surface of the molded component and the mold is illuminated (e.g., with ultraviolet (UV) light from a laser or other suitable UV light source) so as to reduce adhesion between the surface of the molded component and the mold. In some cases, illuminating the interface comprises ablating at least a portion of the surface of the molded component. The molded component is then released from the mold.

The mold may comprise glass, quartz, or sapphire. The molding material may comprise a high-index adhesive, polymer, polycarbonate, polypropylene, or poly(methyl methacrylate). And the molded component may comprise a Fresnel lens, a refractive lens, a diffractive lens, a cylinder lens, an aspheric lens, a contact lens, a spectacle lens, an intraocular lens, a spectacle lens, or a diffraction grating.

Another example of the present technology includes a method of forming a Fresnel lens. A polymer is disposed within a mold that defines a surface of the Fresnel lens, e.g., by injecting the polymer into the mold. The polymer is cured (e.g., by exposure to UV light) within the mold so as to form the Fresnel lens. At least a portion of an interface between a surface of the Fresnel lens and the mold is illuminated with UV light (e.g., transmitted through the mold) so as to reduce adhesion between the surface of the Fresnel lens and the mold. The Fresnel lens is released from the mold. In some cases, a substrate, such as a lens blank, is disposed in contact with the polymer before the polymer is cured.

Yet another example of the present technology includes a molded optical component, such as a Fresnel lens, comprising a hardened adhesive material with a surface that has been at least partially ablated by ultraviolet radiation. The hardened adhesive material may include high-index adhesive, polymer, polycarbonate, polypropylene, and/or poly(methyl methacrylate). The surface of the hardened adhesive material may define at least one feature having a height of up to about 5 μm. And the molded optical component can include a substrate, in contact with the hardened adhesive material, to support the hardened adhesive material.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a perspective view of a transparent mold for a Fresnel lens.

FIG. 1B shows a cross section of the transparent mold of FIG. 1A filled with air.

FIG. 1C is another cross sectional view of the transparent mold shown in FIG. 1A.

FIG. 2A is a perspective view of a Fresnel lens made of a highly adhesive material and formed using the transparent mold of FIGS. 1A-1C.

FIG. 2B shows a cross section of the Fresnel lens of FIG. 2A after being released from the transparent mold using laser ablation.

FIG. 2C is another cross sectional view of the Fresnel lens shown in FIG. 2A.

FIG. 2D is a cross sectional view of the Fresnel lens shown in FIG. 2A disposed on a substrate.

FIG. 2E is a photograph of a molded Fresnel lens formed on a lens blank.

FIG. 3 shows the transparent mold of FIGS. 1A-1C filled with adhesive molding material.

FIG. 4 shows the interface between hardened adhesive molding material and the transparent mold illuminated with ultraviolet light.

FIG. 5 illustrates a process for forming and releasing a molded part made of hardened adhesive molding material using ultraviolet light.

### DETAILED DESCRIPTIONS OF THE DRAWINGS

In one example of the present technology, a mold is made from a material that transmits light (for example, fused silica glass). The material to be molded (for example, an adhesive with a relatively high refractive index, for example, Norland 65, or Mitsui Chemicals MR-10 polymer, with indexes of refraction typically in the range between 1.50 and 1.70) is introduced into this transparent mold, then hardened, for example, by UV light curing or thermal curing. At this point, the hardened material adheres strongly to the transparent mold. The adhesion bond strength can sometimes be greater than the strength of the adhesive or polymer, such that when the hardened adhesive or polymer is pulled away from the mold, some material may break off from the parent mass (molded part) and remain adhered to the mold. Before attempting to separate the hardened material from the transparent mold, a laser pulse is projected through the transparent mold. The laser pulse is of a wavelength selected to (1) pass through the transparent mold without damaging the transparent mold and (2) disrupt the surface molecular bonds of the molded material. An example laser wavelength is 248 nm, which ablates many polymer surfaces. The laser pulse disrupts the top layer of molecules on the surface of the molded material, causing the top layer's adhesiveness to diminish. The molded material may then be easily separated from the mold, with few, if any, molecules removed from the surface of the molded material.

This molding process can be especially useful for making optical components, including Fresnel lenses, refractive lenses, diffractive lenses, cylinder lenses, aspheric lenses, contact lenses, spectacle lenses, intraocular lenses, spectacle lenses, gratings, etc. It is not limited to making optical components or ablation using UV radiation, however; any type of structure that can be molded can be released from the mold with this process. For instance, aluminum structures may be molded, then ablated/released with light at a wavelength of about 532 nm, which is in the visible spectrum (green). Similarly, ceramic insulators may be molded and ablated/released with light at a wavelength of about 1064 nm, which is in the near-infrared (NIR) spectrum.

The mold can be made of any material that can be formed into appropriate shape and that transmits the laser light used to disrupt or partially ablate the surface of the hardened molding material, including but not limited to fused silica, glass, quartz, sapphire, etc. The size of the structures defined by the mold can be as small as sub-micron and/or as large as meters. Generally speaking, the finest feature defined by the mold can be about two wavelengths of the laser light being used (e.g., about 20 nm to about 800 nm in size). The aspect ratio range of the mold can be as high or as low as current molding processes.

Suitable materials to be molded include but are not limited to high index adhesives, MR-10 polymer, polycarbonate, polypropylene, poly(methyl methacrylate) (PMMA), acrylonitrile butadiene styrene (ABS) plastic, and amorphous polyethylene terephthalate (A-PET). A suitable material should be substantially opaque to UV light (light at wavelengths of 405 nm or less), which allows the material to absorb laser energy, causing ablation. If the part is used as a lens or other transmissive component, the material should also be substantially transparent to light at the lens's operating wavelength (e.g., light at wavelengths longer than 405 nm) to provide for good optical performance. However, if the part is not going to be used as an optical lens, then it may be opaque or reflective at visible wavelengths. In this case, virtually any moldable material may be used so long as it can absorb an available laser wavelength and the surface will ablate or vaporize rather than simply melt.

The illumination used to separate the molded part from the mold may be at any wavelength that causes molded material ablation may be used, so long as the mold transmits enough light to allow ablation of the molded material without damaging the mold or the molded material. For example, the illumination may include one or more pulses of ultraviolet light (about 10-400 nm) from a laser, such as pulses of 126, 146, 172, 175, 193, 222, 248, 282, 308, or 351 nm light from an excimer laser. Aluminum and other metals and alloys may be ablated with visible light (about 400-700 nm), and ceramics may be ablated with NIR light (about 700-5000 nm) Any standard laser pulse duration may be used so long as sufficient energy density for ablation occurs. Typical pulse durations range from a few milliseconds to femtoseconds. In some examples, a single pulse is used. In other cases, more than one pulse is used, with a typical range of pulse repetition rates being between a few seconds per pulse to a few billion pulses per second (e.g., up to 100 GHz or more).

A wide beam may illuminate all or substantially all of the interface between the mold and the molded part all at once, or one or more smaller beams may illuminate different areas of the interface, either all at once or in succession. For instance, one or more beams may illuminate the areas where the adhesive contacts the mold to prevent any adhesive from remaining on the mold. For instance, a relatively small beam may be scanned across the interface or directed to different portions of the interface. This could be a single pulse operation if the single pulse has sufficient energy to ablate the entire surface of the molded part that is required to be released, or it could be a multiple pulse operation if insufficient energy is available in a single pulse. In some example cases where adhesion to the mold is borderline (e.g., where occasional non-release occurs), a partial exposure of ablation may be sufficient to allow clean separation to occur. Laser beams can be of almost any size, ranging from several meters of beam diameter to a point less than 1 micron in diameter.

The peak pulse energy is determined by experimentation, and typical energy levels are between milli-Joules and Joules per square cm. Generally, the pulse energy is selected to above the ablation threshold of the molded material (e.g., about 20 mJ/cm² for ABS plastic, about 35 mJ/cm² for A-PET, and about 200 mJ/cm² for PMMA). Although a pulsed laser is the preferred embodiment, a non-pulsed, continuous beam of light could also work, so long as it causes ablation/vaporization rather than only melting.

After the ablation is complete, the force required to remove the molded part from the mold may be small enough to allow the mold to release the molded part with little to no damage to either part. In some cases mere gravity provides sufficient force to remove the molded part from the mold—the mold can simply be flipped upside down, and the molded part falls out. If desired, extra material or bulk may be added to the molded part's size to compensate for any material loss that occurs during ablation. For instance, the molded part may be made thicker, but have the same shape, or the molded part's aspect ratio may be adjusted to account for material loss due to ablation.

Molding a Fresnel Lens from Highly Adhesive Material

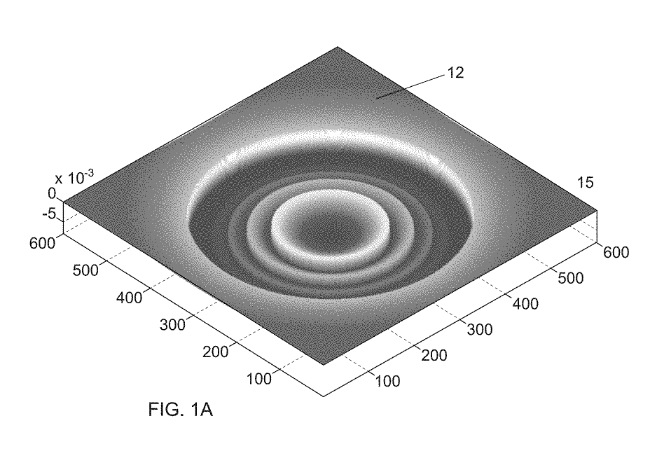

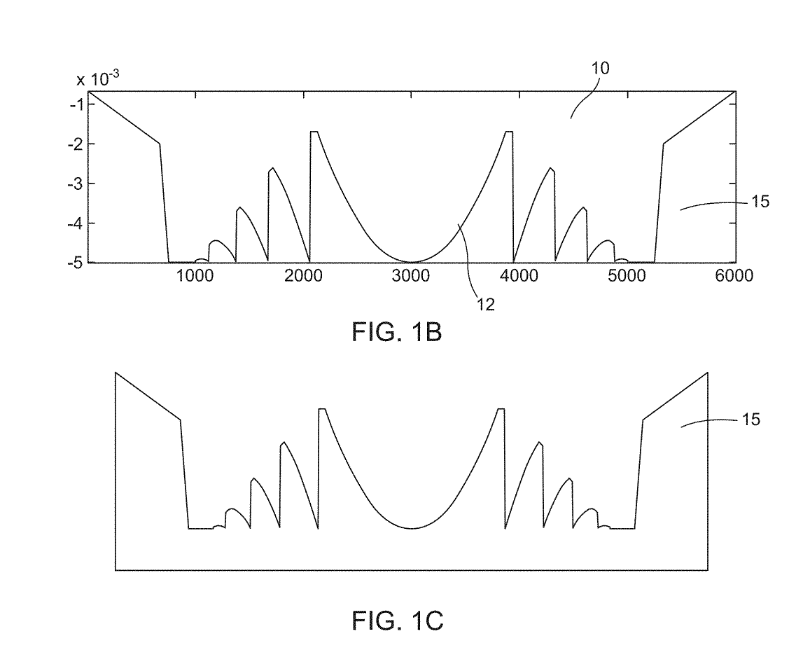

FIG. 1A is a perspective view of an exemplary mold 15 for an optical component. FIGS. 1B and 1C show cross section profiles of the mold 15 filled with air 10. The mold 15 is made from a material, such as fused silica or glass, that is largely transparent at ultraviolet wavelengths (e.g., from about 10 nm to about 400 nm). It is about 6 mm by 6 mm square and has a surface 12 that defines at least one surface of the optical component to be made using the mold 12. In this case, the mold 15 is for a Fresnel lens, so the surface 12 is in the shape of a negative of the Fresnel lens, with a series of concentric, circular ridges with depths on the order of microns (e.g., 1 μm, 2.5 μm, 5 μm, 7.5 μm, or 10 μm) and widths on the order of tens to hundreds of microns (e.g., 10 μm, 25 μm, 50 μm, 75 μm, 100 μm, 125 μm, 150 μm, 200 μm, or 250 μm). Because the ridges on the surface 12 define such fine features, it can be difficult or challenging to remove the Fresnel lens from the mold 15 without damaging or breaking the fine features, especially if the Fresnel lens is made from a material that sticks or adheres to the mold 15.

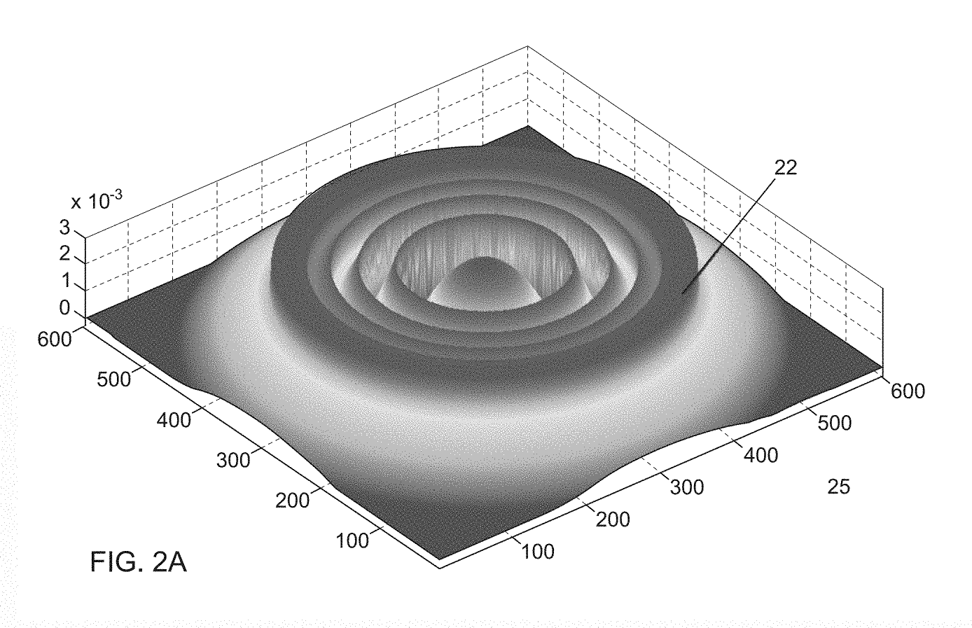

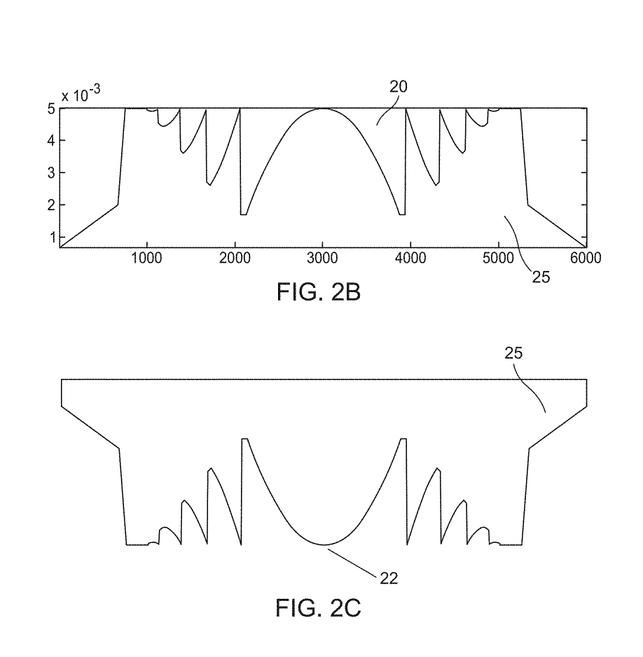

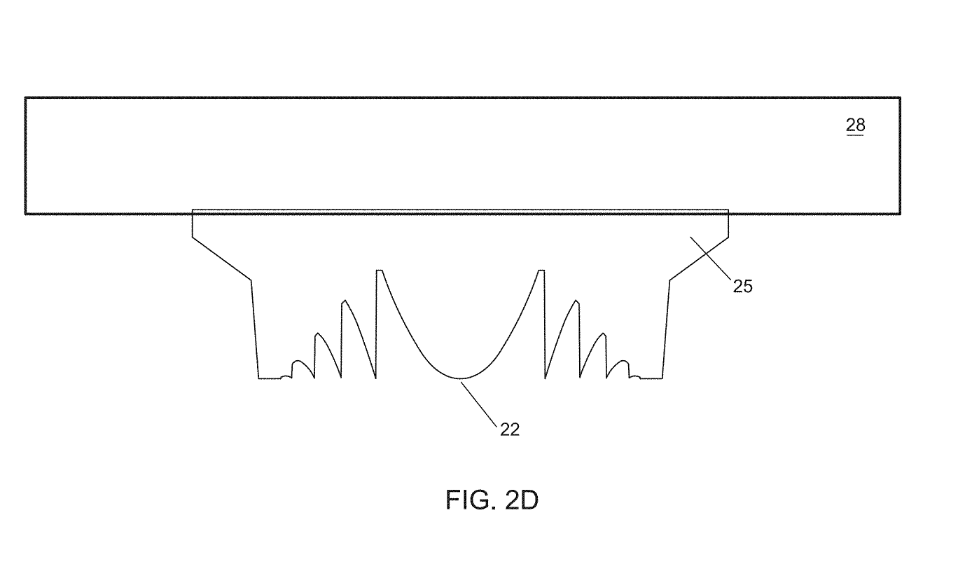

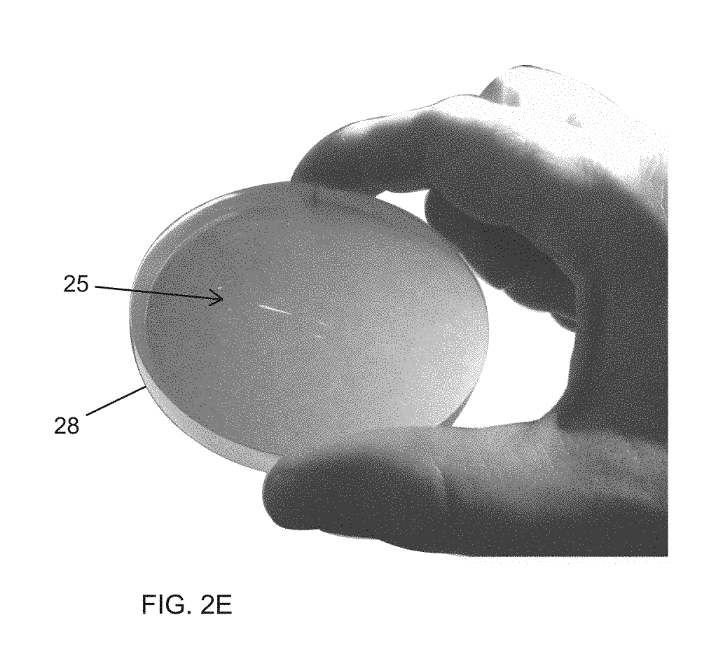

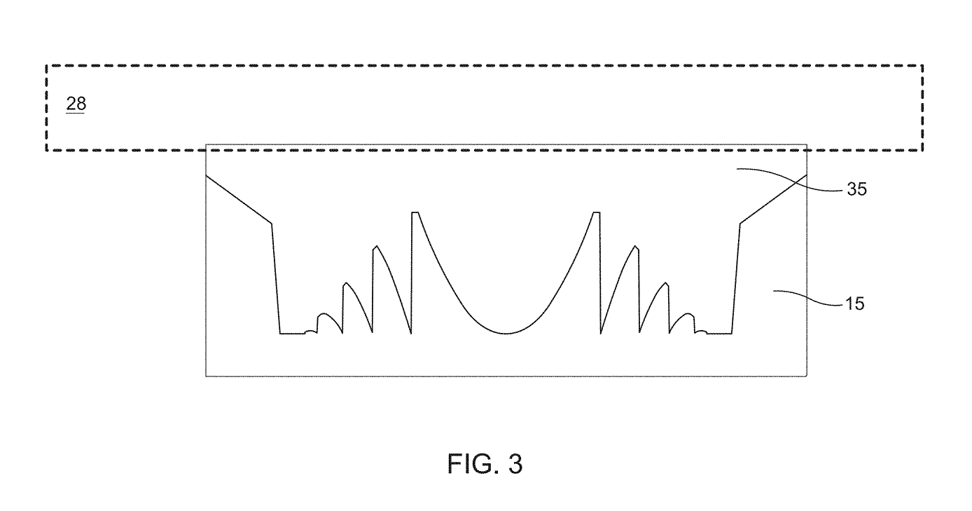

FIG. 2A is a perspective view of an exemplary Fresnel lens 25 made using the mold 15 shown in FIGS. 1A-1C. FIGS. 2B and 2C show cross section profiles of the Fresnel lens 25 in air 20. The Fresnel lens is made of hardened high-index adhesive, MR-10 polymer, polycarbonate, polypropylene, poly(methyl methacrylate), or another suitable material. The Fresnel lens 25 has a diameter of about 6 mm and a height of about 3 μm. It also has a surface 22 that defines concentric rings whose depths range from less than 1 μm to about 4 μm.

FIG. 2D shows the Fresnel lens 25 disposed on a substrate 28, such as a lens blank, piece of glass, plastic, or other suitable material. (FIG. 2E is a photograph of a Fresnel lens on a lens blank for a spectacle lens.) The substrate 28 can also be made of the same high-index adhesive or polymer used to make the Fresnel lens 25. In this, the substrate 28 is a flat piece of material that supports the Fresnel lens 25, which, at a thickness of microns, is too thin to support itself in most environments. In other cases, the substrate 28 may be curved, faceted, or otherwise shaped to refract or diffract incident light or to provide desired mechanical properties (e.g., stress or strain relief). The Fresnel lens 25 and the substrate 28 may be transparent over an overlapping or coincident range of wavelengths (e.g., some or all of the visible spectrum, which ranges from about 400-700 nm). The substrate 28 may also be made from or coated with a material that reflects light through the Fresnel lens 25.

FIG. 3 shows the mold 15 of FIGS. 1A-1C filled with uncured molding material 35. Molding material 35 in this exemplary process is shown as a casting process, but it could be other types of molding processes as well, such as injection molding. A substrate (e.g., a lens blank) may be placed along the top surface (in the frame of reference of FIG. 3) to create a smooth surface or other shaped surface. Once the molding material 35 is in the mold 15 and conformed to the shape of mold 15 (and the optional substrate), it is hardened into the shape of a Fresnel lens. It could be hardened in ways known to those skilled in the art of molding, and some examples are light-activated curing, heat-activated curing, two-part epoxy mixing, thermal flow, etc. For instance, the molding material 35 may be cured with relatively low-intensity UV light to form a molded Fresnel lens 25.

Curing of molding materials typically involves a total energy of 1-10 Joules, and sometimes higher or lower depending upon the material properties. However, the energy concentration should not reach or exceed the threshold level where ablation occurs. Ablation for mold release can typically occur when the energy density reaches and/or exceeds the ablation threshold, which varies substantially with each different material. For example, ABS plastic has an ablation threshold of about 20 mJ/cm2, A-PET has an ablation threshold of about 35 mJ/cm2, and PMMA has an ablation threshold of about 200 mJ/cm2. With experimentation these values can be increased, sometimes many-fold, to optimize the removal rate of the plastic and the surface finish quality desired.

Hardening or curing causes the molded part 25 to adhere strongly to the mold 15. As a result, it can be difficult to remove from the mold 15 without damage to the molded part 25, the mold 15, or both the molded part 25 and the mold 15.

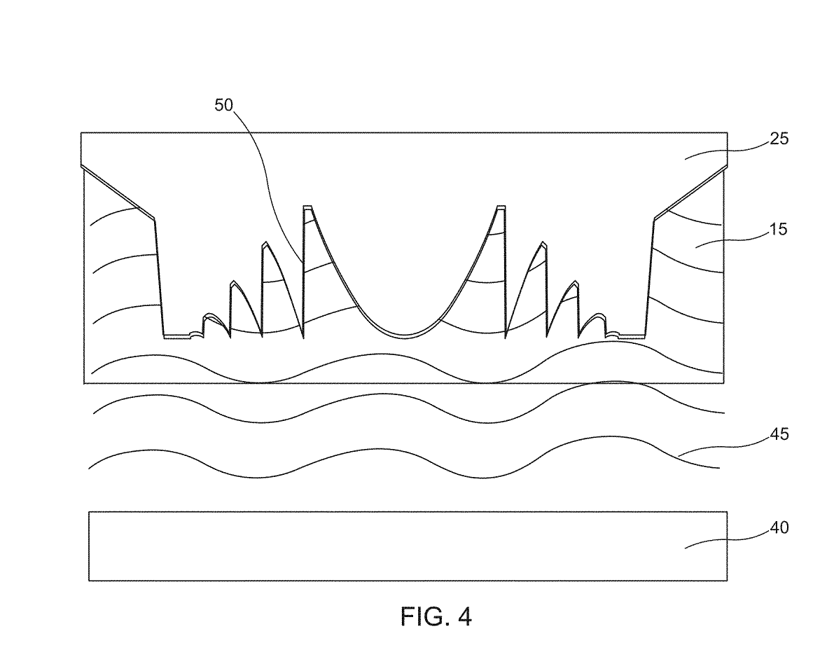

FIG. 4 shows an excimer laser 40 that emits a pulse or pulses 45 of ultraviolet light (e.g., at a wavelength of 248 nm) for releasing the molded Fresnel lens 25 from the mold 15. The pulses of ultraviolet light 45 propagate freely through glass mold 30, and then they encounter the molded part 35 at an interface 50 between the molded part 35 and the mold 30. At the interface 50, the pulses 45 disrupt the surface layer 22 of the Fresnel lens 25. In this exemplary method, the surface layer is at least partially ablated by the ultraviolet light pulses 45. Disruption of the surface layer at the interface 50 breaks the adhesion between the mold 15 and the molded part 25 is broken, and the molded part 25 can be removed from the mold 15 with little to no damage. The surface of the molded part 25 may have a small number of disrupted molecules, but the degree of disruption can be reduced or minimized by controlling the wavelength, number, repetition rate, peak intensity, and energy of the pulses 45. Once disruption is complete, the molded part 25 can be released from the mold 15, e.g., by turning the mold 15 upside down.

Molding an Optical Component with Micron-Scale Features

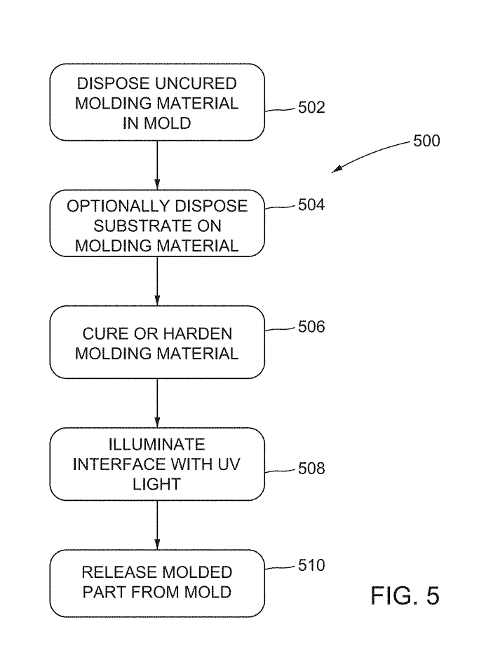

FIG. 5 shows a process 500 for molding an optical component or other part with micron-scale features from a highly adhesive material. In step 502, molding material, such as an optical adhesive or polymer is disposed within a transparent mold. The molding material may be poured or injected into the mold, depending on the shape of the mold and the shape of the part being molded.

In optional step 504, a substrate, such as a lens blank, is disposed in contact with molding material. If the mold is a casting mold, the substrate can be placed on the molding material after the molding material has been poured into the molded. If the mold is an injection mold, the molding material can be injected into a void or cavity formed by the mold and the substrate. The molding material can also be disposed directly onto the substrate, then pressed into the mold by pushing the substrate toward or against the mold.

In some cases, the substrate may support more than one molded optical component. For instance, the substrate may support an array of molded optical components (e.g., an array of micron-scale Fresnel lenses), which can be formed simultaneously using a single mold that defines multiple components or a set of molds. The substrate may also support components molded in sequence using the same mold or a combination of molds.

In step 506, the molding material is cured or hardened using a suitable hardening or curing technique. For instance, the molding material may be irradiated with visible or UV light transmitted through the mold, the substrate, or both. The molding material may also be heated. It can also be mixed with a curing agent, e.g., the second part of a two-part epoxy. Or the molding agent may simply cure or harden over a given period of time.

Once the molding material is hard enough, the interface between the molding material and the mold is illuminated with one or more pulses of UV light from an excimer laser or other suitable light source (step 508). As explained above, the pulses of UV light disrupt and/or ablate the interface, reducing the adhesive or bonding force that causes the hardened molding material to stick to the mold. In some cases, the pulses illuminate the entire interface; in other cases, they illuminate only a part of the interface. For example, the pulses may be scanned in a pattern or at random over the interface. If the molded part is a Fresnel lens, the pulses may be scanned along the concentric rings on the surface of the Fresnel lens. The pulse duration, pulse power, and/or number of pulses directed at each spot may be selected based on the shape and material of the part.

After disruption of the adhesive forces holding the mold and molded part together, the molded part is released from the mold in step 510, e.g., by simply turning the mold upside down so that the molded part falls out of the mold. If the molded part is on a substrate, then the substrate and the mold can be pulled apart without damaging the mold or the molded part. The mold can then be used to make more molded parts.

Those of skill in the art will readily appreciate that the molds, materials, and processes disclosed herein can be used to make a variety of different optical components simply by changing the shape of the mold. For example, appropriately shaped molds may be used to make refractive lenses, diffractive lenses, cylinder lenses, aspheric lenses, contact lenses, spectacle lenses, intraocular lenses, spectacle lenses, gratings, etc. The processes disclosed herein can also be used to make other (i.e., non-optical) components, including aluminum components that are released using green light and ceramic structures that are released using NIR light.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the technology disclosed herein may be implemented using hardware, software or a combination thereof When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the technology disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of forming a molded component using a transparent mold and a molding material, the method comprising:
disposing the molding material in the transparent mold;
hardening the molding material in the transparent mold so as to form the molded component;
illuminating at least a portion of an interface between a surface of the molded component and the mold so as to reduce adhesion between the surface of the molded component and the transparent mold; and
releasing the molded component from the transparent mold.

2. The method of claim 1, wherein the transparent mold comprises at least one of glass, quartz, and sapphire.

3. The method of claim 1, wherein the molding material comprises at least one of a high-index adhesive, polymer, polycarbonate, polypropylene, and poly(methyl methacrylate).

4. The method of claim 1, wherein the molded component comprises a Fresnel lens.

5. The method of claim 1, wherein the molded component comprises at least one of a refractive lens, a diffractive lens, a cylinder lens, an aspheric lens, a contact lens, a spectacle lens, an intraocular lens, a spectacle lens, or a diffraction grating.

6. The method of claim 1, wherein hardening the molding material comprises irradiating the molding material.

7. The method of claim 1, wherein illuminating the at least a portion of the interface between the surface of the molded component and the transparent mold comprises ablating at least a portion of the surface of the molded component.

8. The method of claim 1, wherein illuminating the at least a portion of the interface comprises illuminating the at least a portion of the interface with ultraviolet light.

9. A molded component formed by the method of claim 1.

10. A method of forming a Fresnel lens, the method comprising:
disposing a polymer within a mold, the mold defining a surface of the Fresnel lens;
curing the polymer within the mold so as to form the Fresnel lens;
illuminating at least a portion of an interface between a surface of the Fresnel lens and the mold with ultraviolet light so as to reduce adhesion between the surface of the Fresnel lens and the mold; and
releasing the Fresnel lens from the mold.

11. The method of claim 10, wherein disposing the polymer within the mold comprises disposing injecting the polymer into the mold.

12. The method of claim 10, wherein curing the polymer comprises illuminating the polymer with ultraviolet light.

13. The method of claim 10, wherein illuminating the at least a portion of the interface comprises transmitting the ultraviolet light through mold.

14. The method of claim 10, further comprising:
disposing a substrate in contact with the polymer before curing the polymer.

15. A Fresnel lens formed according to the method of claim 10.

16. A molded optical component comprising:
a hardened adhesive material having a surface at least partially ablated by ultraviolet radiation.

17. The molded optical component of claim 16, wherein the hardened adhesive material comprises at least one of high-index adhesive, polymer, polycarbonate, polypropylene, and poly(methyl methacrylate).

18. The molded optical component of claim 16, wherein the surface defines at least one feature having a height of up to about 5 μm.

19. The molded optical component of claim 16, wherein the molded optical component includes a Fresnel lens.

20. The molded optical component of claim 16, further comprising:
a substrate, in contact with the hardened adhesive material, to support the hardened adhesive material.
